(19) United States
(12) Patent Application Publication
(10) Pub. No.: US 2007/0005930 A1
(43) Pub. Date: Jan. 4, 2007

(54) Systems and methods for host virtual memory reconstitution

(76) Inventors: Hormuzd M. Khosravi, Portland, OR (US); David M. Durham, Hillsboro, OR (US); Travis Schluessler, Hillsboro, OR (US); Ravi Sahita, Beaverton, OR (US); Uday Savagaonkar, Hillsboro, OR (US); Priya Rajagopal, Worcester, MA (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/173,815

(22) Filed: Jun. 30, 2005

(51) Int. Cl. G06F 12/00

(52) U.S. Cl. 711/203

(57) ABSTRACT

Systems and methods are described herein to provide for host virtual memory reconstitution.

### TECHNICAL FIELD

Various embodiments described herein relate generally to computer systems and more particularly to virtual memory reconstitution.

### BACKGROUND

A conventional computing platform may include diagnostic hardware tools. An operator may employ these tools to maintain, monitor and/or troubleshoot the computing platform. Such tools are typically executed within the operating system environment of the platform. Accordingly, the usefulness of these tools is limited if the operating system environment crashes or is otherwise unavailable. Next-generation platforms may include an execution environment that is isolated from host operating system processes.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1A is a high-level block diagram of a system according an example embodiment.

FIG. 1B is a more detailed block diagram of a system according to an example embodiment.

FIG. 2 is a flowchart of a method according to an example embodiment.

FIG. 3 is a flowchart of a method according to an alternate embodiment.

FIG. 4 is a more detailed block diagram of a system according an example embodiment.

FIG. 5 is a more detailed flowchart of a method according to an example embodiment.

FIG. 6 is a block diagram of system according to another embodiment.

### DETAILED DESCRIPTION

The following is a detailed description of some exemplary embodiments of the invention(s) contained within the disclosed subject matter. Such invention(s) may be referred to, individually and/or collectively, herein by the term “invention” merely for convenience and without intending to limit the scope of this application to any single invention or inventive concept if more than one is in fact disclosed. The detailed description refers to the accompanying drawings that form a part hereof and which show by way of illustration, but not of limitation, some specific embodiments of the invention, including a preferred embodiment. These embodiments are described in sufficient detail to enable those of ordinary skill in the art to understand and implement the inventive subject matter. Other embodiments may be utilized and changes may be made without departing from the scope of the inventive subject matter.

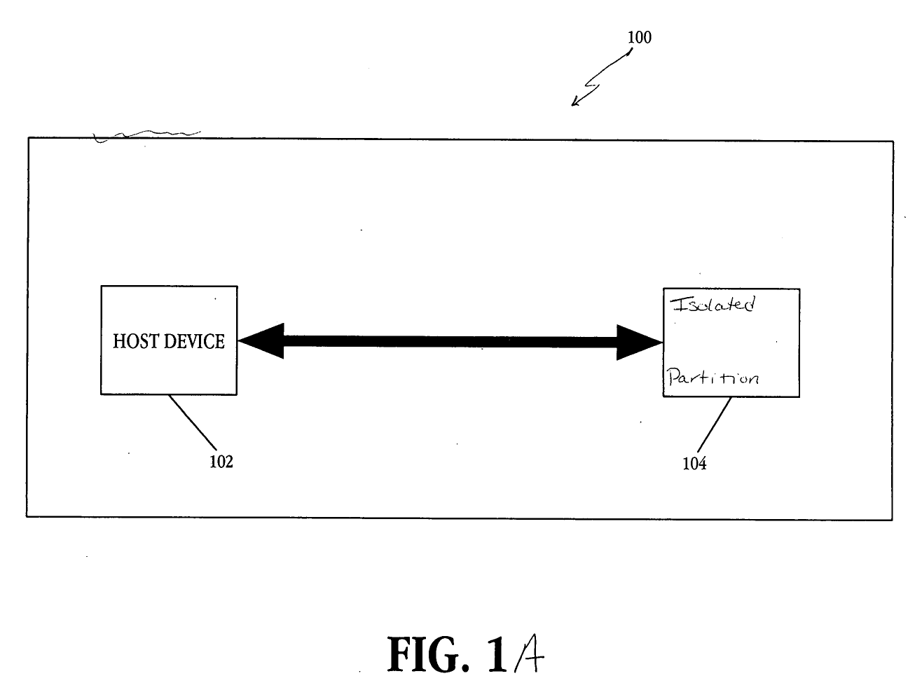

FIG. 1A is a high-level block diagram of a system according to an example embodiment. System 100 includes a host device 102 and an isolated partition 104. The isolated partition 104 is communicatively coupled to the host device 102 through any suitable means. In one embodiment, the host device 102 and the isolated partition 104 are communicatively coupled through a communications bus. The communications bus may represent one or more busses, e.g., USB (Universal Serial Bus), FireWire, PCI, ISA (Industry Standard Architecture), X-Bus, EISA (Extended Industry Standard Architecture), or any other appropriate bus and/or bridge (also called a bus controller).

The host device 102 is configured to perform operations implementing an operating system and other software applications. Operating systems may include operating systems based on Windows®, Unix, Linux, Macintosh®, and operating systems embedded on a processor. The host device 102 may include, without limitation, desktop PC, server PC, PDA, etc. The host device 102 is further configured to run one or more software applications. The software applications include, without limitation, stand alone software applications (i.e. word processing applications, login applications, and the like) and software applications that control hardware devices. Hardware devices include, without limitation, network interface cards, bus controllers, memory controllers, graphics cards, storage controllers and the like.

The isolated partition 104 is configured to perform reconstitution of virtual memory on the host device 102. Reconstitution of virtual memory is the ability to translate the host device's 102 virtual and logical memory addresses to the host device's 102 physical memory addresses. The virtual memory reconstitution methods are independent of the operating system running on the host device. In one embodiment the virtual memory reconstitution methods use the IA 32 processor memory management unit to retrieve the information needed to reconstitute the virtual memory of the host device 102.

The isolated partition 104 is an isolated execution environment that is securely separated from the host device 102. The isolated partition 104 may be, but is not limited to, a service processor, a virtual partition, an embedded microcontroller, and the like. In one embodiment, the “isolated execution environment” is an execution environment that is configured to execute code independently and securely isolated from a host that it is communicatively coupled to. In a further embodiment, the isolated execution environment is further configured to prevent software running on the host from performing operations that would alter, modify, read, or otherwise affect the code store or executable code that is running in the isolated execution environment.

In an embodiment, the host device 102 is configured to send processor register data from the host device to the isolated partition 104. In such an arrangement, the isolated partition 104 is configured to receive the processor register data and perform virtual memory reconstitution operations using that data.

FIG. 1B is a more detailed block diagram of a system according to an example embodiment. The system 100 includes a host device 102 and an isolated partition 104 communicatively coupled. The host device 102 includes a Virtual to Physical Bootstrap Agent (“V2P Bootstrap Agent”) 206. The isolated partition 104 includes a Virtual to Physical Mapper (“V2P Mapper”) 208 and a memory interface 210.

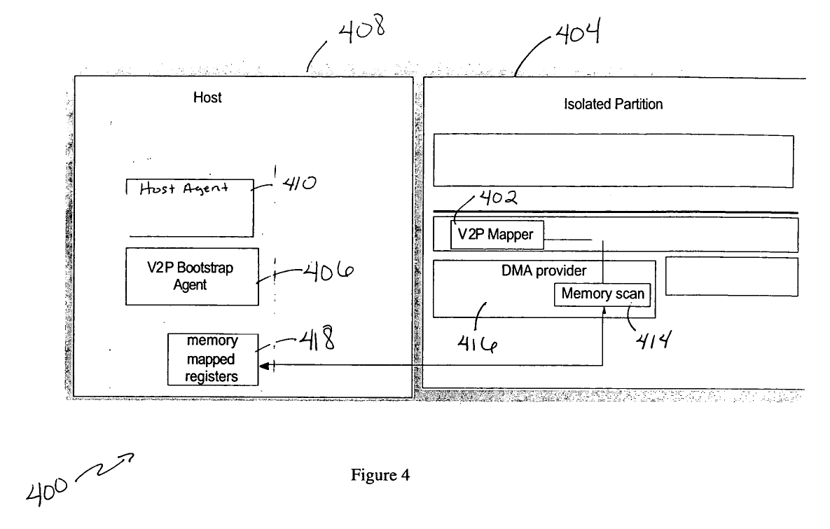

The V2P Bootstrap Agent 206 of the host device 102 is configured to provide information about the host processor registers needed for reading the host page tables. In one embodiment, the host processor registers include the Global Descriptor Table Register (GDTR), the Local Descriptor Table Register (LDTR), and Control Register 3 (CR3). The V2P Bootstrap Agent 206 may be software or firmware. In another embodiment, the V2P Bootstrap Agent 206 may be a combination of hardware devices and software resources. V2P Bootstrap Agent 206 is discussed in greater detail below with respect to FIG. 4.

The memory interface 210 is configured to pass data between the host device 206 and the isolated partition 208. In one embodiment, the memory interface 210 uses Direct Memory Access (DMA) to access the host device memory. In another embodiment, the memory interface is configured to directly read memory mapped registers of the host device 102 independent of the host device 102.

The V2P Mapper 208 of the isolated partition 104 is configured to receive a host virtual memory address from host device 102 and to access a host page table on the host device 102 to translate the host virtual memory address to a host physical memory address. The V2P Mapper 208 may be software or firmware. In another embodiment, the V2P Mapper 208 may be a combination of hardware devices and software resources. V2P Mapper 208 is discussed in greater detail below with respect to FIG. 4.

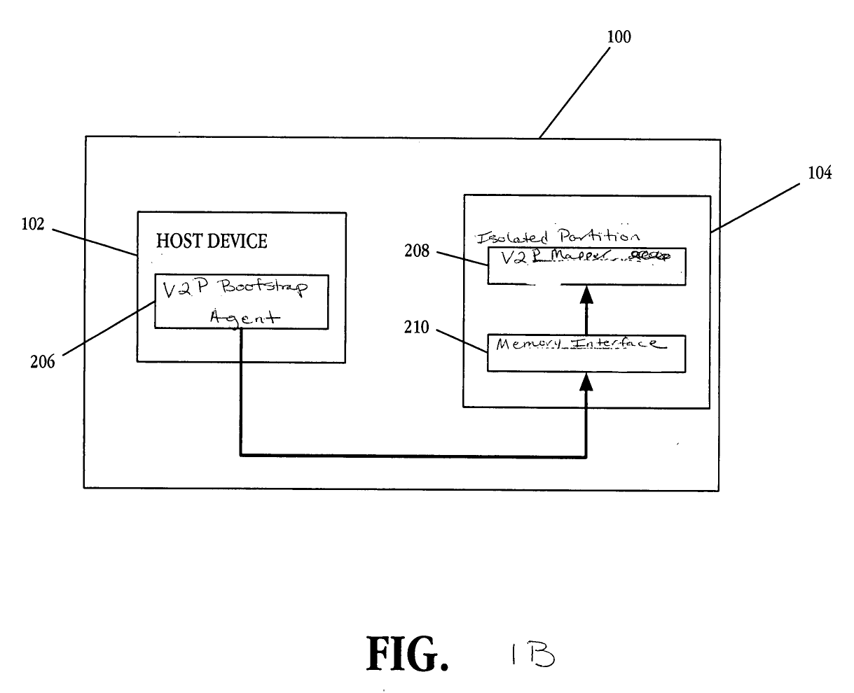

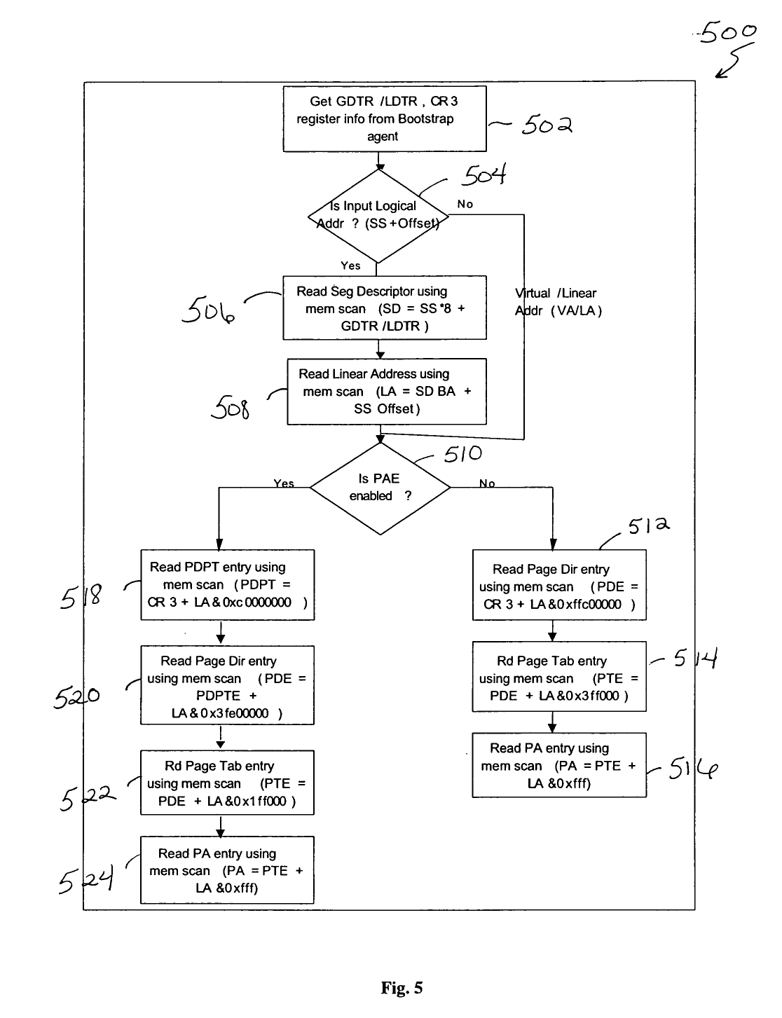

FIG. 2 is a flowchart of a method according to an example embodiment. In an embodiment, the operations in FIG. 2 are carried out in an isolated partition. As discussed above, the isolated partition 104 is configured to perform reconstitution of virtual memory on the host device 102. At block 202, a host virtual memory address is received from a host device. At block 204, a host page table on the host device is accessed to translate the host virtual memory address to the host physical memory address. Methods performed by the V2P Mapper are described in greater detail below with respect to FIG. 5.

In an embodiment, the operations depicted in FIG. 2 are performed on behalf of a third party device on the isolated partition 108 requiring the contents of memory, the contents of memory to be used by the third party device to perform management functions. Management functions include, without limitation, management controller activities and host software agent measurement. In another embodiment, the third party device includes a capability module. In such an arrangement the capability module is configured to perform management activities. In one embodiment, the capability module requests supported event types from a management core on the isolated partition 108. In such an arrangement, during host device start-up or the hot-swapping of a hardware component coupled to the host device 102, the management core queries one or more host device drivers on the host device 102 for event types supported by the host device driver. The management core receives a response to the query and caches the event types supported by the host device drivers on the host device 102. The management core receives the request for event types from the capability module and determines which of the event types cached match the request. The capability modules registered to the event type can then subscribe to that event type and perform management activities using event data related to that event type. In the context of the present discussion, the capability module requires the contents of a virtual memory address to perform one or more of those management activities. The management core, using the V2P mapper, receives the request from the capability module, translates the virtual memory address in the request to a physical memory address and then retrieves the contents of the physical memory address and returns that to the capability module.

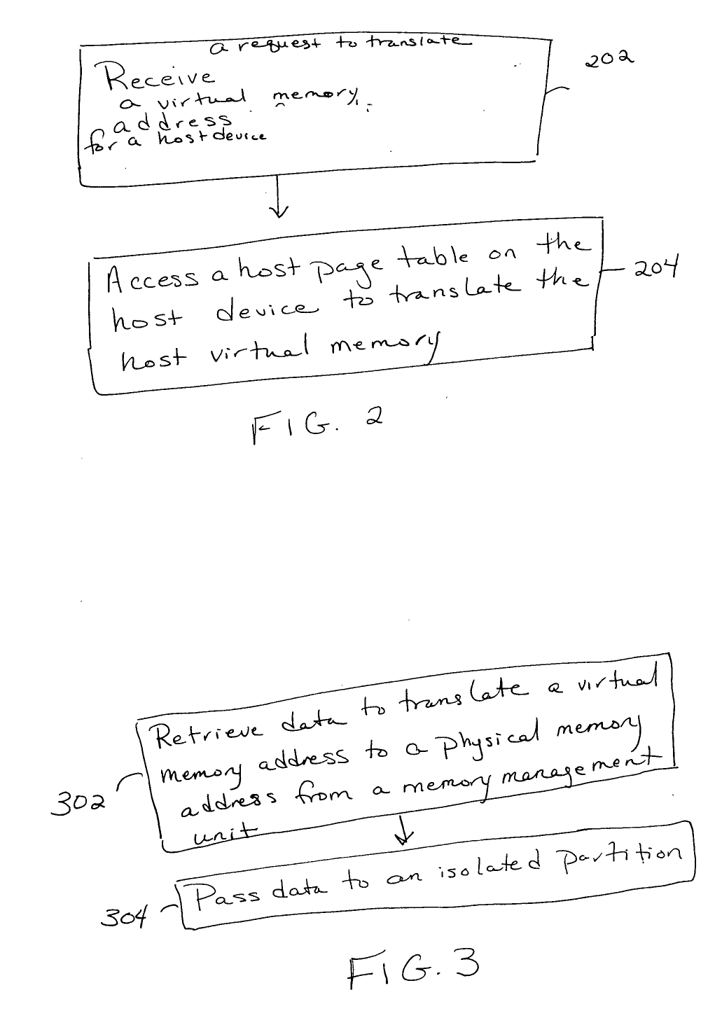

FIG. 3 is a flowchart of a method according to an alternate embodiment. In an embodiment, the operations depicted in FIG. 3 show operations carried out on a host device 102. As discussed above, the host device is configured to provide host processor register information to the isolated partition 104. At block 302, data to translate a virtual memory address to a physical memory address is retrieved. At block 304, the data is passed to an isolated partition.

FIG. 4 is a more detailed block diagram of a system according to an example embodiment. FIG. 4 illustrates one example of components of a virtual memory reconstitution system 400. System 400 comprises a V2P Mapper 402 running on an isolated partition 404, and a V2P Bootstrap agent 406 running on a host 408. In one example, V2P Mapper 402 resides on the isolated partition 404 and maps host virtual and logical addresses to physical addresses. V2P Bootstrap agent 406 runs in the System Management Mode of the host processor, in one example, and in another example, V2P Bootstrap agent 406 runs as a host kernel (ring-0) component.

When a component of the isolated partition 404 would like to access memory space allocated to a host agent 410, V2P Mapper 402 must first map the virtual address of host agent 410 to locate the memory space of host agent 410 in physical memory. In one example, host agent 410 and V2P Bootstrap agent 406 are located with the Host Device Drivers 412.

In one embodiment, the component includes a capability module on the isolated partition 208, the capability module to receive and process event management data and to perform management activities based on that data.

In order to successfully map addresses, V2P Bootstrap agent 406 provides V2P Mapper 402 with information from the host processor registers that V2P Mapper needs to read the host page tables. In one example, these registers include the Global Descriptor Table Register (GDTR), Local Descriptor Table Register (LDTR), and Control Register 3 (CR3). Once V2P Mapper 402 has received the page table data, V2P Mapper 402 maps the virtual or logical address into a physical address.

FIG. 5 is a more detailed flowchart of a method according to an example embodiment. In an example embodiment, the operations depicted in FIG. 5 are carried out on an isolated partition 104 as discussed above with respect to FIGS. 1 and 2.

In one embodiment, the method 500 in FIG. 5 begins by a V2P Mapper acquiring host processor register information from a Host Bootstrap agent at block 502. The register information is needed to access host processor page tables. In one embodiment, the register information includes the Global Descriptor Table Register (GDTR), the Local Descriptor Table Register (LDTR), and Control Register 3 (CR3).

In one embodiment, the method 500 continues at block 504 by V2P Mapper receiving an input address to be reconstituted and determining if the address is a logical address. In one embodiment, V2P Mapper determines if the address is logical by checking to see if the input address has a 16 bit Segment Selector (SS) and a 32 bit Offset. If V2P Mapper determines that the input address is not a logical address, then the address is a linear/virtual address and V2P Mapper can skip to linear address translation as block 510. If V2P Mapper determines that the input address is a logical address, V2P Mapper then translates the logical address to a linear address.

In one embodiment, translation of the logical address to a linear address begins at block 506 by V2P Mapper reading the Segment Descriptor. In one embodiment, the V2P Mapper calculates the Segment Descriptor (SD) address by multiplying the 13 bit index from the Segment Selector of the logical addresses by eight (8) and adding in the GDTR or LDTR base address. A Table Indicator (TI) bit within the Segment Selector indicates whether the GDTR or LDTR base address should be used. Once the Segment Descriptor address has been calculated, V2P Mapper uses an associated memory scan capability to read the Segment Descriptor and obtain the Segment Descriptor Base Address (SD BA)

In one embodiment, translation of the logical address continues at block 508 with the V2P Mapper calculating the linear/virtual address. V2P Mapper adds the SD BA to the logical address offset (SS Offset). The result of this addition is the linear address.

At block 510, according to an example embodiment, V2P Mapper determines if Physical Address Extension (PAE) is enabled. V2P Mapper can determine if PAE is enabled by checking the PAE flag of Control Register 4 (CR4) on the host processor. In one example, the entry of CR4 is obtained from Host Bootstrap Agent.

Referring to block 512 of the method 500 when PAE is not enabled, V2P Mapper then reads the Page Directory entry (PDE) of the linear address according to an example embodiment. V2P Mapper calculates the address of the Page Directory entry by adding the entry of CR3 to bits 22-31 of the linear address. Bits 22-31 of the Linear address are obtained by multiplying the linear address by ffc00000 (LA×ffc00000). Using an associated memory scan capability, V2P Mapper reads the calculated PDE address to obtain the PDE in example embodiment.

In one embodiment, the method 500 continues at block 514 when PAE is not enabled by V2P Mapper reading the PTE of the linear address. V2P Mapper calculates the address of the PTE by adding the PDE to bits 12-21 of the linear address. Bits 12-21 of the Linear address are obtained by multiplying the linear address by 3ff000 (LA×3ff000). Using an associated memory scan capability V2P Mapper reads the calculated PTE address and obtains the PTE.

Concluding one alternative to the method 500 at block 516 when PAE is not enabled V2P Mapper reads the Page Address (PA) of the linear address. V2P Mapper calculates the Page Address by adding the PTE to bits 0-11 of the linear address. Bits 0-11 of the Linear address are obtained by multiplying the linear address by fff (LA×fff). Using an associated memory scan capability V2P Mapper reads the calculated Page Address and obtains the Page information.

Referring back to block 518 of the method 500 when PAE is enabled, V2P Mapper reads the Page Directory Pointer Table (PDPT) entry of the linear address. V2P Mapper calculates the address of PDPT entry by adding the entry of CR3 to Bits 30 and 31 of the linear address. Bits 30 and 31 of the Linear address are obtained by multiplying the linear address by c0000000 (LA×c00000000). Using an associated memory scan capability V2P Mapper reads the calculated PDPT address to obtain the PDPT entry.

In one embodiment, the method 500 continues at block 520 when PAE is enabled by V2P Mapper reading the Page Directory entry (PDE) of the linear address. V2P Mapper calculates the address of the Page Directory entry by adding the PDPT entry to bits 20-29, of the linear address. Bits 20-29 of the Linear address are obtained by multiplying the linear address by 3fe00000 (LA×3fe000000). Using an associated memory scan capability V2P Mapper reads the calculated PDE address to obtain the PDE.

In one embodiment, at block 522 the method 500 continues when PAE is enabled by V2P Mapper reading the PTE of the linear address. V2P Mapper calculates the address of the PTE by adding the PDE to bits 11-19 of the linear address. Bits 11-19 of the Linear address are obtained by multiplying the linear address by 1ff000 (LA×1ff000). Using an associated memory scan capability V2P Mapper reads the calculated PTE address and obtains the PTE. Concluding another alternative to the method 500 at block 524 when PAE is enabled V2P Mapper reads the Page Address (PA) of the linear address. V2P Mapper calculates the Page Address by adding the PTE to bits 0-11 of the linear address. Bits 0-11 of the Linear address are obtained by multiplying the linear address by fff (LA×fff). The Page Address is the final physical address of the Page. Using an associated memory scan capability V2P Mapper reads the final physical address and obtains the data of the Page. Embodiments of the invention are not limited to the example described by reference to FIG. 5.

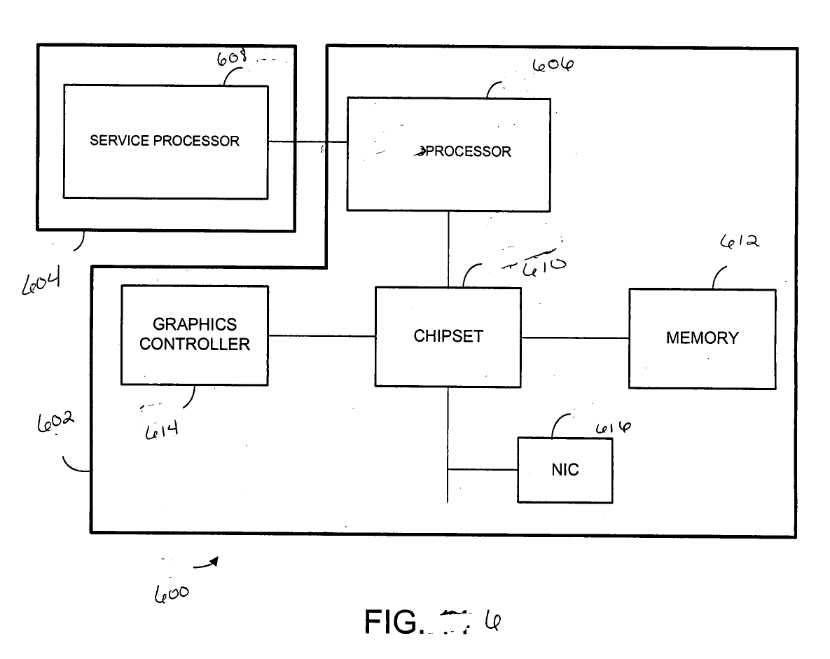

FIG. 6 is a block diagram of system according to another embodiment. System 600 includes an isolated partition 604 and host device 602. Isolated partition 604 includes a service processor 608 which may execute functions attributed to virtual memory reconstitution. Host device 602 comprises processor 606. Host device 602 also includes chipset 610 and memory 612. Memory 612 may comprise any suitable type of memory, including but not limited to Single Data Rate Random Access Memory and Double Data Rate Random Access Memory. Other functional units of host device 602 include graphics controller 614 and Network Interface Controller (NIC) 616, each of which may communicate with processor 606 via chipset 610.

Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments of the invention. Combinations of the above embodiments and other embodiments not specifically described herein will be apparent to those of skill in the art upon reviewing the above description.

The Abstract of the Disclosure is provided to comply with 37 C.F.R. §1.72(b), requiring an abstract that allows the reader to quickly ascertain the nature of the technical disclosure. It is submitted with the understanding that it will not be used to interpret or limit the scope or meaning of the claims. Additionally, in the foregoing Detailed Description, it can be seen that various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment. In the appended claims, the terms “including” and “in which” are used as the plain-English equivalents of the terms “comprising” and “wherein,” respectively. Moreover, the terms “first,” “second,” and “third,” etc. are used merely as labels, and are not intended to impose numerical requirements on their objects.

What is claimed is:

1. A method comprising:
receiving a request to translate a virtual memory address for a host device from a third party device; and
accessing a host page table on the host device to translate the virtual memory address to a physical memory address.

2. The method of claim 1 further comprising retrieving data from the physical memory address.

3. The method of claim 2 wherein retrieving data is performed using a DMA memory scan.

4. The method of claim 1, further comprising accessing additional noncontiguous host physical memory addresses corresponding to an area of virtual memory.

5. The method of claim 1 further comprising:
receiving a host logical memory address from the host device; and
referencing a host descriptor table one the host device to translate the host logical memory address to a second host virtual memory address.

6. A machine-accessible medium having machine executable instructions contained therein, which when executed perform operations comprising:
providing, by a host device having virtual memory, access to the virtual memory; and
accessing, from an isolated partition, the virtual memory on the host device.

7. The medium of claim 6 wherein accessing the virtual memory is performed from the isolated partition by referencing page table entries of the host device.

8. The medium of claim 7 further comprising determining a host physical memory address from the page table entries.

9. The medium of claim 7 wherein referencing the host page table entries is performed using a Page Directory Table if a Page Address Extension is not enabled.

10. The medium of claim 7 wherein referencing the host page table is performed using a Page Directory Pointer Table if a Page Address Extension is enabled.

11. An apparatus comprising:
a memory to store executable program code;
a memory management unit; and
a processor to operate in conjunction with the executable program code to:
retrieve, from the memory management unit on a host, data to translate a virtual memory address to a physical memory address; and
pass the data to a service processor.

12. The apparatus of claim 11 wherein memory stores page tables.

13. The apparatus of claim 12 wherein page tables comprise a page directory pointer table, a page directory table, and a page entry table.

14. The apparatus of claim 11 wherein the processor further comprises descriptor table registers.

15. The apparatus of claim 14, wherein descriptor table registers comprise a global descriptor table register and a local descriptor table register.

16. The apparatus of claim 11 wherein the processor further comprises control registers.

17. The apparatus of claim 16 wherein the control registers comprise control register 3.

18. A system comprising:
an isolated partition, the isolated partition having a module to reconstitute virtual memory;
a host device including:
memory to store executable program code;
a memory management unit; and
a processor to operate in conjunction with the executable program code to:
retrieve, from the memory management unit, data to translate a virtual memory address to a physical memory address; and
pass the data to the isolated partition;
a PCI bus to communicatively couple the host device to the isolated partition.

19. The system of claim 18 wherein the isolated partition comprises a service processor.

20. The system of claim 18 wherein the executable program code runs in a system management mode of the processor.

21. The system of claim 18 wherein executable program code runs as a kernel agent on the processor.
